(19) United States
(12) Patent Application Publication
(10) Pub. No.: US 2017/0230320 A1
(43) Pub. Date: Aug. 10, 2017

(54) Transmitting Media Content During Instant Messaging

(71) Applicant: MICROSOFT TECHNOLOGY LICENSING, LLC, Redmond, WA (US)

(72) Inventors: Mark Alan Richard Knight, Biggleswade (GB); Maxim Anatolyevich Silchev, Moscow (RU)

(21) Appl. No.: 14/617,889

(22) PCT Filed: Oct. 29, 2014
(86) PCT No.: PCT/RU2014/000824

§ 371 Date: Feb. 9, 2015

(51) Int. Cl. H04L 12/58; H04L 29/08; H04L 29/06

(52) U.S. Cl. CPC H04L 51/10; H04L 51/04; H04L 65/1089; H04L 65/601; H04L 51/063; H04L 67/146; H04L 61/1582

(57) ABSTRACT

A method implemented at a network entity during an instant messaging communication session conducted between a plurality of user terminals over a communications network, the method comprising: receiving a request over the communications network from one of said user terminals, the request comprising a uniform resource indicator that has been exchanged in an instant message during the instant messaging communication session; retrieving media content associated with the uniform resource indicator from a further network entity connected to said network; storing the retrieved media content in a data store connected to said network; and transmitting a response to said user terminal, the response comprising one of (i) at least one identifier of a location in the data store where the retrieved media content was stored; and (ii) the retrieved media content.

### RELATED APPLICATIONS

This application claims benefit of priority of PCT Application Serial No. PCT/RU2014/000824, filed Oct. 29, 2014, the disclosure of which is incorporate in its entirety.

### BACKGROUND

Packet-based communication systems allow the user of a device, such as a personal computer, to communicate across the computer network using a packet protocol such as Internet Protocol (IP). Packet-based communication systems can be used for various types of communication events. Communication events which can be established include voice calls, video calls, instant messaging, voice mail, file transfer and others.

These systems are beneficial to the user as they are often of significantly lower cost than fixed line or mobile networks. This may particularly be the case for long-distance communication. To use a packet-based system, the user installs and executes client software on their device. The client software provides the packet-based connections as well as other functions such as registration and authentication.

Communications systems allow users of devices to communicate across a computer network such as the internet. Communication events which can be established include voice calls, video calls, instant messages, voice mail, file transfers and others.

An instant messaging communication session allows a chat to be conducted between users of computer devices via a computer network. Each user can enter text into a field, actuate a send button and thereby create an instant message which is communicated to another user.

It is known that a web address of a website (in the form of a uniform resource indicator (URI) may be transmitted in an instant message by a sender. This URI may for example be a uniform resource locator URL. The recipient, upon receiving this instant message, may choose to select the URL and will be directed to the website. It is common in instant messaging for a sender to share links to video hosting websites, image hosting websites, social media website and news stories etc.

### SUMMARY

According to a first aspect of the present disclosure there is provided a method implemented at a network entity during an instant messaging communication session conducted between a plurality of user terminals over a communications network, the method comprising: receiving a request over the communications network from one of said user terminals, the request comprising a uniform resource indicator that has been exchanged in an instant message during the instant messaging communication session; retrieving media content associated with the uniform resource indicator from a further network entity connected to said network; storing the retrieved media content in a data store connected to said network; and transmitting a response to said user terminal, the response comprising one of (i) at least one identifier of a location in the data store where the retrieved media content was stored; and (ii) the retrieved media content.

According to another aspect of the present disclosure there is provided a network entity comprising a network interface and a module, wherein the module is configured to: receive, via the network interface, a request transmitted over a communications network from a user terminal during an instant messaging communication session conducted between the user terminal and at least one further user terminal over the communications network, the request comprising a uniform resource indicator that has been exchanged in an instant message during the instant messaging communication session; retrieve media content associated with the uniform resource indicator from a further network entity connected to said network; store the retrieved media content in a data store connected to said network; and transmit a response to said user terminal, the response comprising one of (i) at least one identifier of a location in the data store where the retrieved media content was stored; and (ii) the retrieved media content.

According to another aspect of the present disclosure there is provided a computer program product, the computer program product being embodied on a non-transient computer-readable medium and configured so as when executed on a processor of a network entity during an instant messaging communication session conducted between a plurality of user terminals over a communications network, to perform any of the methods described herein.

According to another aspect of the present disclosure there is provided a method implemented at a user terminal during an instant messaging communication session conducted with at least one further user terminal over a communications network, the method comprising: displaying a message exchanged during the instant messaging communication session on a display of the user terminal; detecting that the message comprises a uniform resource indicator; in response to said detection, automatically transmitting a request to a network entity over the communications network, the request comprising said uniform resource indicator; receiving a response from said network entity, the response comprising at least one of (i) at least one identifier of a location in a data store connected to the network where media content associated with the uniform resource indicator is stored; and (ii) media content associated with the uniform resource indicator; and modifying the displayed message in accordance with at least the media content associated with the uniform resource indicator.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

For a better understanding of the present disclosure and to show how the same may be put into effect, reference will now be made, by way of example, to the following drawings in which:

FIG. 1 shows a communication system;

FIG. 2 shows a schematic view of a user terminal;

FIG. 3a illustrates a flow chart for a process performed by a communication client application for display of media content;

FIG. 3b illustrates a flow chart for a process performed by a network entity for providing webpage metadata to a communication client application;

FIG. 4 illustrates an example client user interface provided by a communication client application; and

FIG. 5a-e illustrates a client user interface displaying a modified received instant message in accordance with various exemplary embodiments.

### DETAILED DESCRIPTION

Embodiments of the present disclosure are described by way of example only.

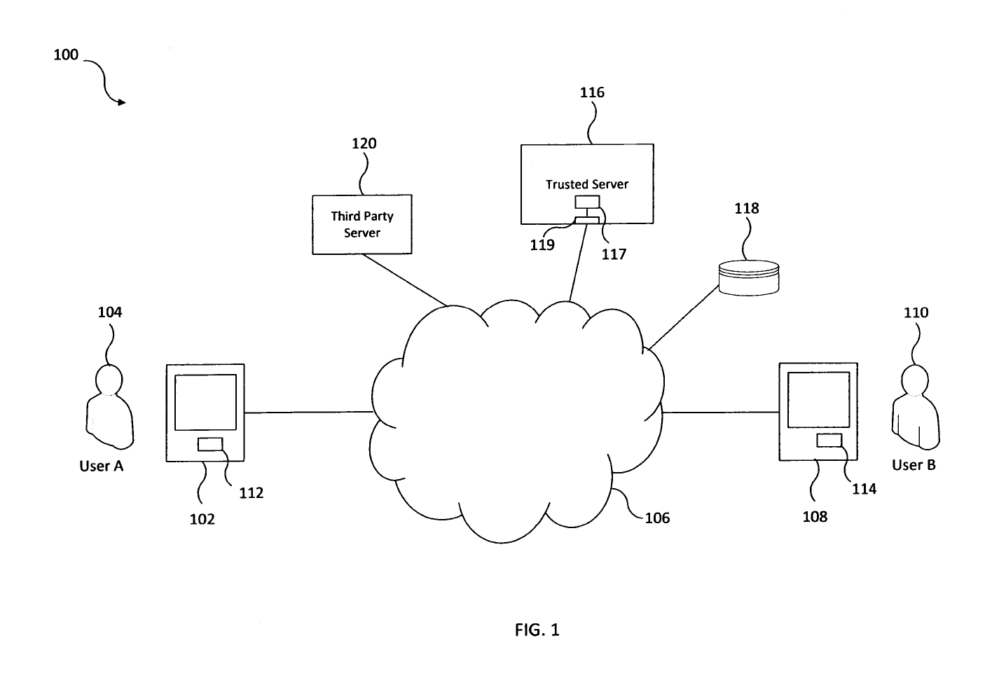

FIG. 1 shows a communication system 100 comprising a first user 104 (User A) who is associated with a user terminal 102 and a second user 110 (User B) who is associated with a user terminal 108. The user terminals 102 and 108 can communicate over a communication network 106 in the communication system 100, thereby allowing the users 104 and 110 to communicate with each other over the communication network 106. The communication network 106 may be any suitable network which has the ability to provide a communication channel between the user terminal 102 and the second user terminal 108. For example, the communication network 106 may be the Internet or another type of network such as a High data rate mobile network, such as a 3^{rd} generation (“3G”) mobile network.

Note that in alternative embodiments, user terminals can connect to the communication network 106 via an additional intermediate network not shown in FIG. 1. For example, if the user terminal 102 is a mobile device, then it can connect to the communication network 106 via a cellular mobile network (not shown in FIG. 1), for example a GSM or UMTS network. User terminals participating in an instant messaging communication conducted over the communication network 106 may connect to the network 106 via the same or different types of network connection. For example user terminal 102 may connect to the communication network 106 via a Wi-Fi connection, and the user terminal 108 may connect to the communication network 106 via a cellular mobile network (e.g. 2G/3G/4G etc.)

The user terminal 102 may be, for example, a mobile phone, a personal digital assistant (“PDA”), a personal computer (“PC”) (including, for example, Windows™, Mac OS™ and Linux™ PCs), a tablet computer, a gaming device or other embedded device able to connect to the communication network 106. The user terminal 102 is arranged to receive information from and output information to User A 104.

The user terminal 102 executes a communication client application 112, provided by a software provider associated with the communication system 100. The communication client application 112 is a software program executed on a local processor in the user terminal 102. The communication client application 112 performs the processing required at the user terminal 102 in order for the user terminal 102 to transmit and receive data over the communication system 100. The communication client application 112 executed at the user terminal 102 may be authenticated to communicate over the communication system through the presentation of digital certificates (e.g. to prove that user 104 is a genuine subscriber of the communication system—described in more detail in WO 2005/009019).

The user terminal 108 may correspond to the user terminal 102. The user terminal 108 executes, on a local processor, a communication client application 114 which corresponds to the communication client application 112 executed at the user terminal 102. The communication client application 114 at the user terminal 108 performs the processing required to allow User 110 to communicate over the network 106 in the same way that the communication client application 112 at the user terminal 102 performs the processing required to allow the User A 104 to communicate over the network 106. The user terminals 102 and 108 are end points in the communication system. FIG. 1 shows only two users (104 and 110) and two user terminals (102 and 108) for clarity, but many more users and user devices may be included in the communication system 100, and may communicate over the communication system 100 using respective communication clients executed on the respective user devices, as is known in the art.

The messages exchanged during an instant messaging communication session are transmitted over the network 106. Connected to the network 106 is network entity (e.g. server 116) which is associated with the software provider referred to above, and therefore a communication client application exchanging data with server 116 will not be exposed to any viruses, malware, spyware or any other malicious code. Thus server 116 is referred to herein as a “trusted server”. The server 116 comprises a URL preview module 117 (which will be described in more detail below) and a network interface 119 for transmission and receipt of data over the communications network.

As shown in FIG. 1, the trusted server 116 is connected to a memory 118 which may be in the form of a data cache for storing data. Whilst FIG. 1 shows a single server 116 and a single cache 118 in the communication network 106, the functionality of the server 116 and cache 118 (described in more detail below) may be distributed over a plurality of computing devices connected to the communication network 106, for example in a “cloud computing” environment. The cache may for example be a component of a content delivery network (CDN) as is known in the art.

FIG. 1 further illustrates another server 120 connected to the communication network 106. Server 120 is a web server configured to store, process and deliver webpages to client devices. Server 120 is not associated with the software provider referred to above, therefore is referred to herein as a “third party server”. Whilst a single third party server 120 has been shown in FIG. 1 for clarity purposes, persons skilled in the art will appreciate that many third party servers may be connected to the communication network 106.

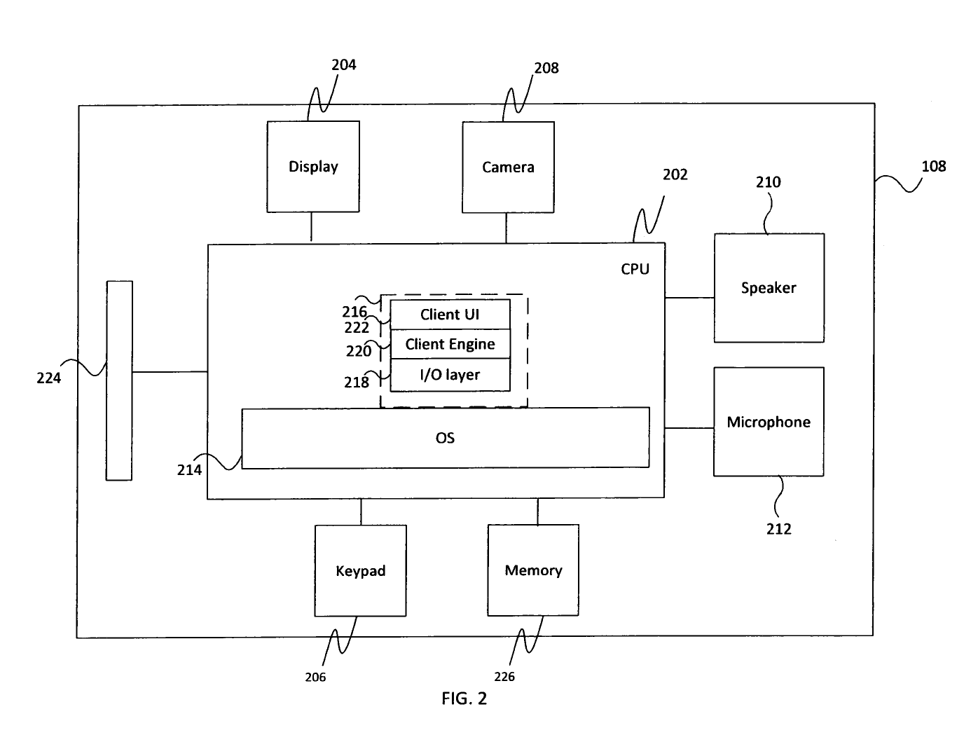

FIG. 2 illustrates a detailed view of the user terminal 108 on which is executed a communication client application 114 for communicating over the communication system 100. The user terminal 108 comprises a central processing unit (“CPU”) 202, to which is connected a display 204 such as a screen or touch screen, input devices such as a keypad 206, a camera 208, and touch screen 204. An output audio device 210 (e.g. a speaker) and an input audio device 212 (e.g. a microphone) are connected to the CPU 202. The display 204, keypad 206, camera 208, output audio device 210 and input audio device 212 may be integrated into the user terminal 108 as shown in FIG. 2. In alternative user terminals one or more of the display 204, the keypad 206, the camera 208, the output audio device 210 and the input audio device 212 may not be integrated into the user terminal 102 and may be connected to the CPU 202 via respective interfaces. One example of such an interface is a USB interface. The CPU 202 is connected to a network interface 224 such as a modem for communication with the communication network 106. The network interface 224 may be integrated into the user terminal 108 as shown in FIG. 2. In alternative user terminals the network interface 224 is not integrated into the user terminal 108. The user terminal 108 also comprises a memory 226 for storing data as is known in the art. The memory 226 may be a permanent memory, such as ROM. The memory 226 may alternatively be a temporary memory, such as RAM.

The user terminal 108 is installed with the communication client application 114, in that the communication client application 114 is stored in the memory 226 and arranged for execution on the CPU 202. FIG. 2 also illustrates an operating system (“OS”) 214 executed on the CPU 202. Running on top of the OS 214 is a software stack 216 for the communication client application 114 referred to above. The software stack shows an I/O layer 218, a client engine layer 220 and a client user interface layer (“UI”) 222. Each layer is responsible for specific functions. Because each layer usually communicates with two other layers, they are regarded as being arranged in a stack as shown in FIG. 2. The operating system 214 manages the hardware resources of the computer and handles data being transmitted to and from the communication network 106 via the network interface 224. The I/O layer 218 comprises audio and/or video codecs which receive incoming encoded streams and decodes them for output to speaker 210 and/or display 204 as appropriate, and which receive unencoded audio and/or video data from the microphone 212 and/or camera 208 and encodes them for transmission as streams to other end-user terminals of the communication system 100. The client engine layer 220 handles the connection management functions of the VoIP system as discussed above, such as establishing calls or other connections by server-based or P2P address look-up and authentication. The client engine may also be responsible for other secondary functions not discussed herein. The client engine 220 also communicates with the client user interface layer 222. The client engine 220 may be arranged to control the client user interface layer 222 to present information to the user of the user terminal 108 via the user interface of the communication client application 114 which is displayed on the display 204 and to receive information from the user of the user terminal 108 via the user interface.

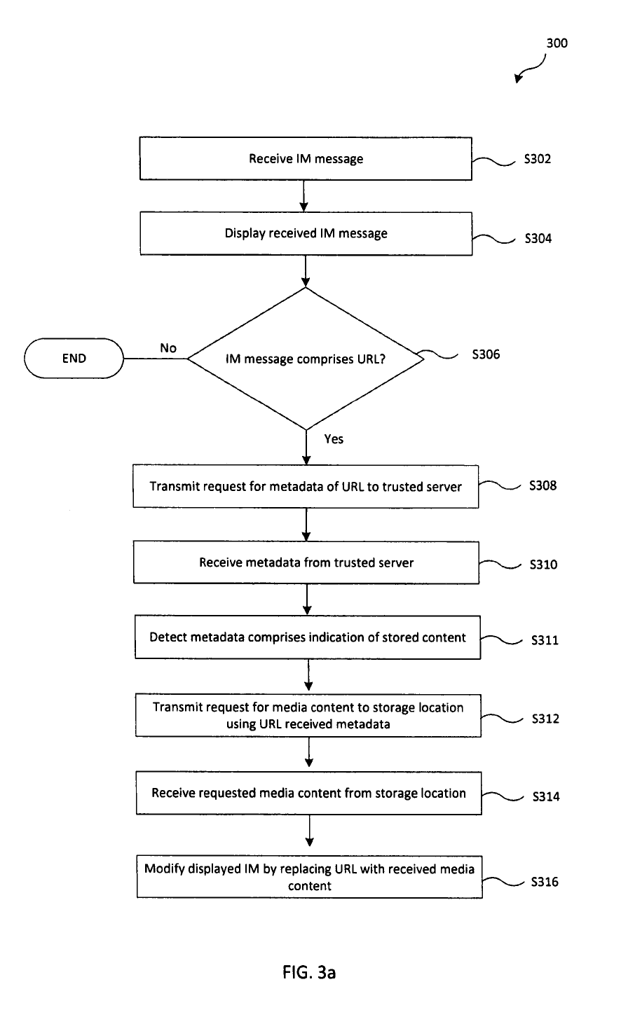

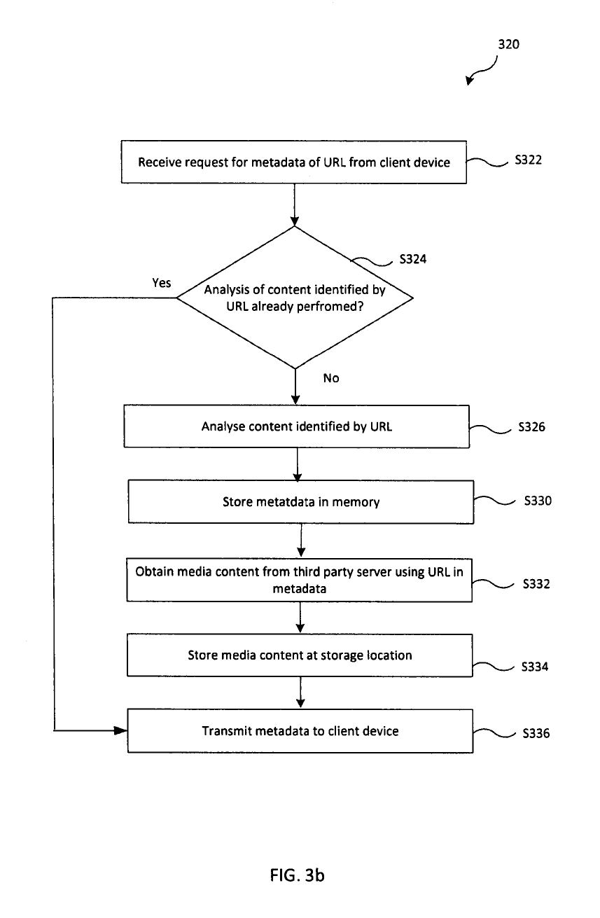

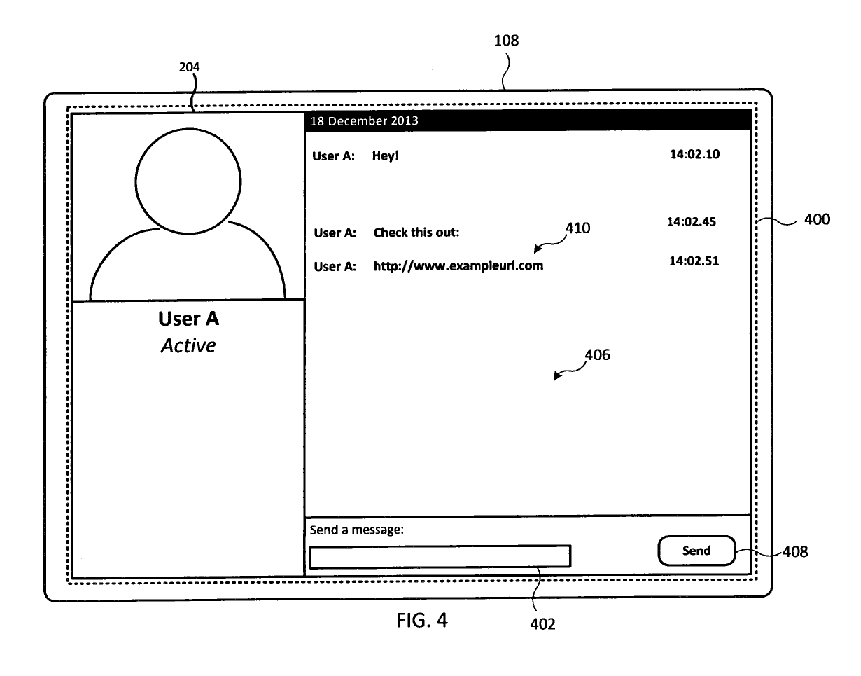

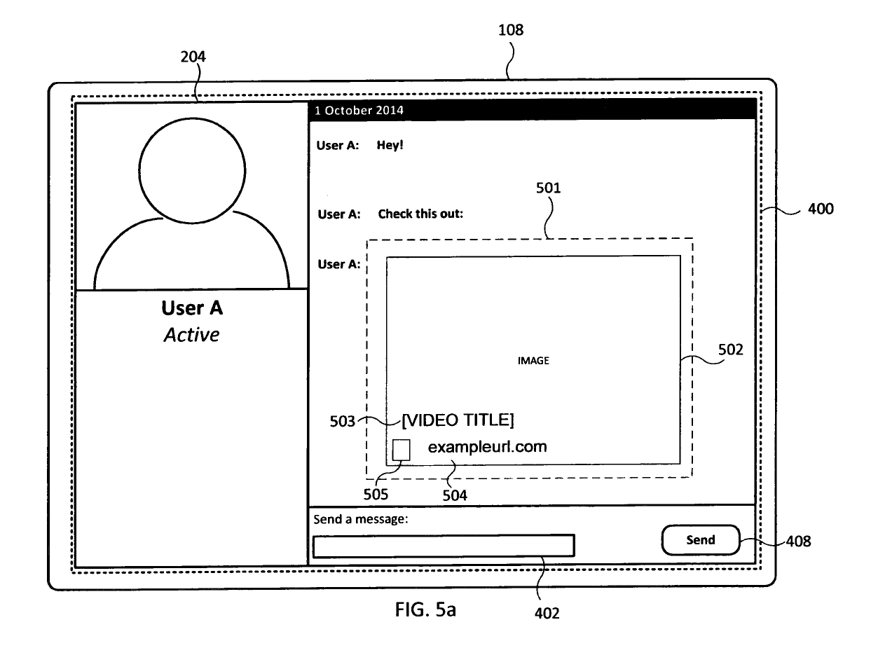

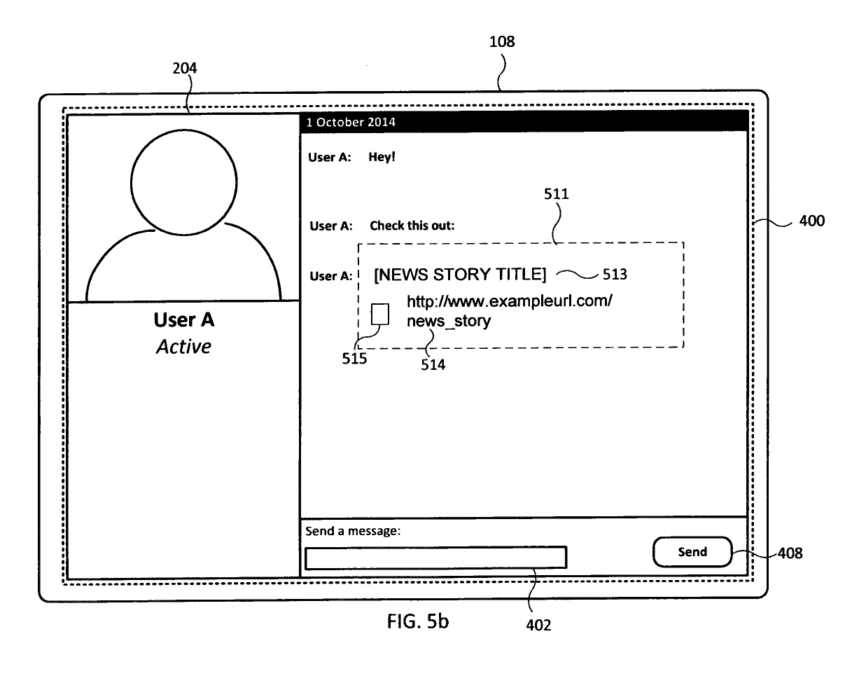

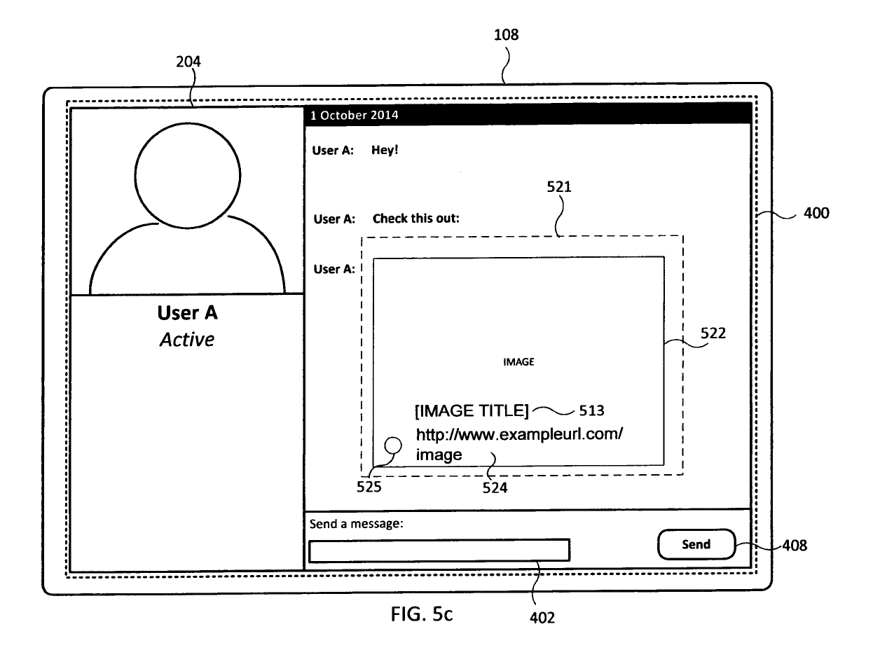

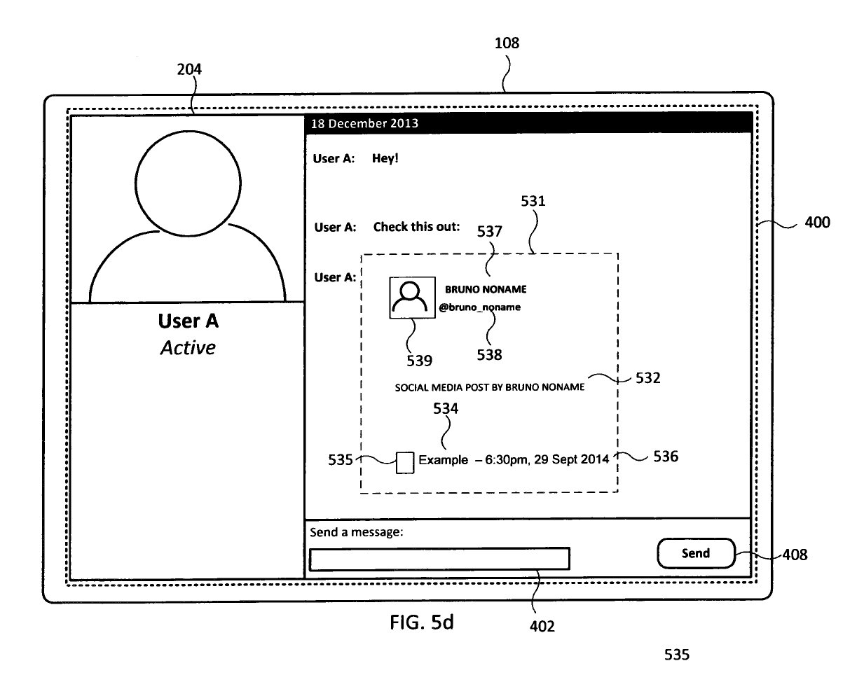

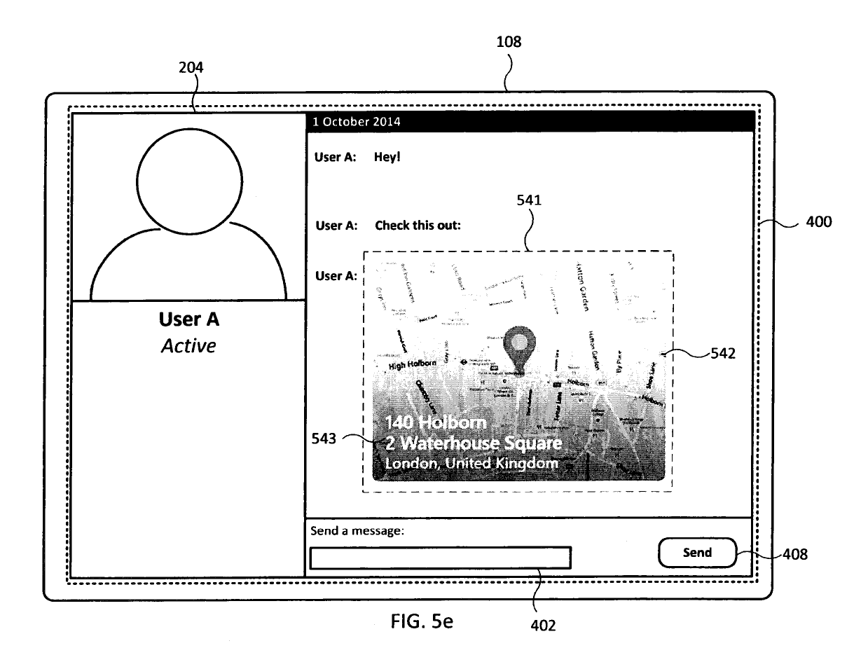

A method implemented during a communication event between a plurality of user devices (otherwise referred to as user terminals herein) over the communications network 106 will now be described with reference to FIGS. 3a, 3b, and 3c and to FIGS. 4, 5a, 5b, 5c, 5d and 5e which illustrate exemplary client user interfaces presented in various embodiments.

Embodiments of the present disclosure are described with reference to User A 104 and User B 110 engaging in an instant messaging conversation whereby messages are transmitted and received between the first user terminal 102 and the second user terminal 108 in an instant messaging communication session.

During the instant messaging conversation, messages may be transmitted in both directions (that is, from the first user terminal 102 to the second user terminal 108 and vice versa) with User A 104 instigating transmission of new messages in response to receipt of received messages from User B 110 and vice versa. The instant messaging conversation may include more than two users and the instant messages may be transmitted between any of the users in the conversation.

The messages in the communication session are transmitted over the communication network 106.

Reference is first made to FIG. 3a which is a flow chart for a process 300 performed by the communication client application 114 executed on the second user terminal 108.

At step S302, the communication client application 114 receives an instant message from the first user terminal 102, and at step S304, the communication client application 114 displays the received message in the client user interface that is displayed on display 204 of the second user terminal 108.

At step S306, the communication client application 114 processes the received instant message to determine if the received instant message comprises a URL.

As shown in, FIG. 3, if it is determined at step S306 that the received instant message does not comprise a URL, then the process 300 ends.

FIG. 4 illustrates an example client user interface provided by the communication client application 114 that is displayed on display 204 of the second user terminal 108.

The client user interface is operable to display text input by User B 110 to be transmitted in a message of the instant messaging communication session but which has not yet been transmitted. Specifically, the client 114 displays via the client user interface a message field 402 into which User B 110 is able to enter text using for example the touch screen 204 or keypad 206. The client user interface displays a selectable send option 408 which User B 110 can select after inputting such text. In response, the client 114 creates a message containing the input text and transmits the created message via the communication network 106 to the first user terminal 102. As shown in FIG. 4, the client user interface comprises an area 406 in which transmitted and received messages are displayed during the instant messaging communication session.

FIG. 4 illustrates three instant messages that have been received by the second user terminal 108 from the first user terminal 102. As shown in FIG. 4, the third instant message comprises a URL 410 “http://www.exampleurl.com”.

Referring back to FIG. 3a, if it is determined at step S306 that the received instant message does comprise a URL then the process 300 proceeds to step S308. At step S308, the communication client application 114 transmits a request for metadata over the communication network 106 to the trusted server 116, the request specifying the URL that was detected at step S306.

Reference is now made to FIG. 3b which is a flow chart for a process 320 performed by the URL preview module 117 on the trusted server 116.

At step S322, the URL preview module 117 receives a request for metadata via the network interface 119, this request corresponds to the request transmitted by the communication client application 114 described above with reference to step S308 of the process S300.

At step S324, the URL preview module 117 determines whether it has previously analysed content identified by the URL in the request received at step S322.

If the URL preview module 117 determines at step S324 that it has not previously analysed content identified by the URL in the request received at step S322, then the process proceeds to step S326.

At step S326, the URL preview module 117 analyses the content identified by the URL to determine metadata associated with the URL. The term “metadata” is used herein to refer to data associated with, or describing third party media content.

It will be appreciated that the URL may point to a HTML webpage. In this scenario, at step S326 the URL preview module 117 communicates with the third party server 120 to download the HTML page source code text of the webpage identified by the URL, and performs an HTML page parsing process on the downloaded HTML page source code text downloaded. The URL preview module 117 may download the full HTML page source code text of the webpage identified by the URL, or only portions of the source code text required to prepare a URL preview picture/thumbnail (for direct links to images, videos, documents, archives, executable, etc.). The HTML page parsing process comprises extracting metadata from the HTML page source code text. The process of HTML page parsing is well known to persons skilled in the art and is therefore not described in detail herein.

It will be appreciated that the URL may point to content (e.g. image, video, archive, document, executable etc.) directly. In this scenario, at step S326 the URL preview module 117 communicates with the third party server 120 to download the content accessible by the URL in the request. The URL preview module 117 may not download the whole of the content completely, but only some parts of it to generate a preview (due to the size of the content and therefore the time required to download it). Once the content has been downloaded to the trusted server 116, the URL preview module 117 is able to determine metadata that is associated with the content.

The metadata determined at step S326 comprises the URL that has been analysed, and may comprise one or more of the following properties in dependence on the type of content that is pointed to by the URL:
(i) A title on the webpage—for example a title of a video, an image, a piece of text (e.g. a news story).
(ii) A URL of a favicon (a small icon) that is associated with the analysed URL.
(iii) A URL of an image which can represent content pointed to by the analysed URL.
(iv) A description of the content (e.g. html page, but may be also: image, video, document, archives, executable) pointed to by the analysed URL.
(v) An indication of the type of content pointed to by the analysed URL, for example HTML for text on the webpage, JPEG for an image displayed on the webpage, and MPEG-4 for a video playable on the webpage.
(vi) A category—provides a classification of content pointed to by the URL. This informs the communication client application which visualization template should be used to provide a preview of the URL
(vii) A username—applicable when the URL is of a social media webpage, this gives an indication of the owner of the data on the webpage, whereby the username is used by the owner to log-in to their social media account.
(viii) A user picture—applicable when the URL is of a social media webpage, a URL of an image (e.g. avatar) used by the owner of the data on the webpage to represent themselves to other users.
(ix) A profile name—applicable when the URL is of a social media webpage, this gives an indication of the owner of the data on the webpage, whereby the profile name is used by the owner identify themselves to other users.
(x) Creation time—indicates time of content creation, in dependence on the time passed since the content was created this may specify the exact time of content creation, or specify the time passed since content creation.
(xi) Size—applicable when the analysed URL points to content (e.g. image, video, archive, document etc.) directly, gives indication of size of content.
(xii) Duration—applicable for a URL pointing directly to video content (e.g. direct link to video file stored at a storage location in the network 106), gives an indication of the length of a video playable on the webpage.
(xiii) Status code—a request transmitted by the URL preview module 117 to the third party server 120 may fail due to several reasons (for example: the given URL is no longer valid, access was denied e.g. authorization required, the site uses an incorrect/outdated SSL Certificate). This property is used to inform the communication client application regarding the reason for URL preview generation failure.
(xiv) Price—applicable when the URL is of an webpage of an online retailer

Once the URL preview module 117 has analysed the content identified by the URL to determine metadata associated with the URL, the process 320 proceeds to step S330, where the URL preview module 117 stores the extracted metadata (output from the HTML page parsing process) in memory on the server 116 and in cache 118 (persistent storage).

In the scenario where the URL points to a HTML webpage, the URL preview module 117 is able to determine from the extracted metadata of the URL that the extracted metadata comprises an indication of media content stored by the third party server 120 that is accessible by one or more further URL. In response to determining that the extracted metadata comprises an indication of media content stored by the third party server 120 that is accessible by one or more further URL, at step S332 the URL preview module 117 communicates with the third party server 120 that stores the media content to access the content accessible at the further URL(s). Once the media content has been retrieved, the URL preview module 117 stores the media content in the cache 118 at step S334.

It will be appreciated that in the scenario where the URL points to content directly, steps S332 is not performed, as the URL preview module 117 obtains the media content as part of step S326.

Regardless of whether media content was retrieved at step S326 or S332, at step S334 the URL preview module 117 stores the retrieved media content in the cache 118.

In embodiments, the URL preview module 117 may store the media content in the cache 118 at step S334 in the form that it was retrieved from the third party server 120. The URL preview module 117 may generate a preview image of the media content and store the preview image in the cache.

At step S336, the URL preview module 117 transmits an indication of a storage location in the cache 118 where the media content (or preview image of the media content) was stored at step S334. At step S336, the URL preview module 117 may additionally transmit other metadata determined at step S326.

Referring back to step S324, it can be seen that the URL preview module 117 is able to determine whether it has previously performed a HTML page parsing process on the webpage identified by the URL in the request received at step S322, by determining whether metadata comprising the URL (identified in the request received at step S322) is stored in memory on the server 116.

If the URL preview module 117 determines at step S324 that it has previously performed a HTML page parsing process on the webpage identified by the URL in the request received at step S322, then the URL preview module 117 retrieves the previously extracted metadata from the memory on the server 116 and then the process 320 proceeds to step S336.

Reference back to the process 300 (shown in FIG. 3a) performed by the communication client application 114 executed on the second user terminal 108.

At step S310, the communication client application 114 receives metadata from the trusted server 116. This metadata corresponds to the metadata transmitted by the URL preview module 117 described above with reference to step S336 of the process S320.

At step S311, the communication client application 114 detects that the metadata received from the trusted server 116 comprises an indication of stored media content in the cache 118 that is accessible by one or more URL. For example a URL of a favicon, a URL of a preview image of a video or other image or a URL of a user picture.

At step S312, for each URL detected at step S311, the communication client application 114 automatically (without any user interaction with the communication client application 114) transmits a request for the media content to the cache 118, the request comprising the URL detected at step S311.

At step S314, the communication client application 114 receives the media content from the cache that was requested at step S312.

At step S316, the communication client application 114 modifies the instant message displayed at step S304 in accordance with at least one of the metadata received at step S310 and the media content received at step S314 to provide a preview of the URL. The manner in which the communication client application 114 displays metadata and media content is preconfigured in the communication client application 114.

Whilst it has been described above that the URL preview module 117 may store the media content in the cache 118 at step S334 in the form that it was retrieved from the third party server 120. The inventors have recognised that this media content may be of a high resolution and therefore have a large data size and therefore it may not be suitable for the communication client application 114 to access the media content in its original form. For example, due to the fact that the display 204 of the second user terminal is of a size that means it can only display media content at a limited resolution. and/or the capabilities of the network connection between the trusted server 116 and the second user terminal 108 over the communication network which will results in poor performance due to a low data rate of the network connection. Optionally, the trusted server 116 may optimise the media content prior to storing the media content in the cache 118 by scaling the image(s) to reduce its data size. This optional optimisation may be based on the detected device capabilities of the second user terminal 108 and/or detected characteristics of the network connection between the trusted server 116 and the second user terminal 108

The communication client application 114 may identify the device capabilities of the second user terminal 108 and/or detected characteristics of the network connection between the trusted server 116 and the second user terminal 108 in the request for metadata transmitted to the trusted server 116 at step 308.

The device capabilities of the second user terminal 108 may comprise one or more of the resolution of the display 204, a version of the communication client application 114 executed on the second user terminal 108. The characteristics of the network connection between the trusted server 116 and the second user terminal 108 may comprise one or more of the type of network connection (for example Wi-Fi, or a mobile connection such as GSM EDGE-Evolution, UMTS, LTE etc.), the speed of the network connection, and the latency of the network connection.

Reference is now made to 5a, 5b, 5c, 5d and 5e which illustrate exemplary client user interfaces presented in various embodiments.

FIG. 5a illustrates a client user interface that is presented by the communication client application 114 in response to detecting the URL of a video hosting website “http://www.exampleurl.com/video” in a received IM message.

In the example of FIG. 5a, the metadata received from the trusted server 116 at step S310 comprises the URL “http://www.exampleurl.com/video”, a title of a video, a URL of a storage location in cache 118 of preview image of the video and a URL of a storage location in cache 118 of a favicon. In accordance with embodiments described above, the communication client application 114 transmits a request for the favicon to the cache 118 (the request comprising the URL of the favicon identified in the received metadata), and a request for the preview image to the cache 118 (the request comprising the URL of the thumbnail image identified in the received metadata). In response to transmitting these requests the communication client application 114 receives the favicon and thumbnail image from the cache 118.

The communication client application 114 modifies the received instant message displayed in the client user interface in accordance with the received metadata and media content.

As shown in FIG. 5a, in an area 501 the received instant message is replaced with a received thumbnail 502 image, the title of the video 503, the URL 504, and the received favicon 505. As shown in FIG. 5a, the title of the video 503, the URL 504, and the received favicon 505 may all be overlaid on the displayed thumbnail 502.

FIG. 5b illustrates a client user interface that is presented by the communication client application 114 in response to detecting the URL of a news website “http://www.exampleurl.com/news_story”.

In the example of FIG. 5a, the metadata received from the trusted server 116 at step S310 comprises the URL “http://www.exampleurl.com/news_story”, a title of a news story, and a URL of a storage location in cache 118 of a favicon. In this example, the received metadata does not comprise a URL of a storage location in cache 118 of a thumbnail image associated with the news story). In accordance with embodiments described above, the communication client application 114 transmits a request for the favicon to the cache 118 (the request comprising the URL of the favicon identified in the received metadata). In response to transmitting this request the communication client application 114 receives the favicon from the cache 118.

The communication client application 114 modifies the received instant message displayed in the client user interface in accordance with the received metadata and media content.

As shown in FIG. 5b, in an area 511 the received instant message is replaced with the title of the news story 513, the URL 514, and the received favicon 515 associated with the URL “http://www.exampleurl.com/news_story”.

FIG. 5c illustrates a client user interface that is presented by the communication client application 114 in response to detecting the URL of an image hosting website. “http://www.exampleurl.com/image” in a received IM message.

In the example of FIG. 5c, the metadata received from the trusted server 116 at step S310 comprises the URL “http://www.exampleurl.com/image”, a title of an image, and a URL of a favicon, and a URL of a storage location in cache 118 of the image displayed on the URL “http://www.exampleurl.com/image”. In accordance with embodiments described above, the communication client application 114 transmits a request for the favicon to the cache 118 (the request comprising the URL of the favicon identified in the received metadata), and a request for the image to the cache 118 (the request comprising the URL of the image identified in the received metadata). In response to transmitting these requests the communication client application 114 receives the favicon and thumbnail image from the cache 118.

The communication client application 114 modifies the received instant message displayed in the client user interface in accordance with the received metadata and media content.

As shown in FIG. 5c, in an area 521 the received instant message is replaced with a received thumbnail 522 image, the title of the image 523, the URL 524, and the received favicon 525 associated with the URL “http://www.exampleurl.com/image”. As shown in FIG. 5c, the title of the image 523, the URL 524, and the favicon 525 may all be overlaid on the displayed thumbnail 522.

FIG. 5d illustrates a client user interface that is presented by the communication client application 114 in response to detecting the URL of a social media website. “http://www.exampleurl.com/bruno_noname/post” in a received IM message.

In the example of FIG. 5d, the metadata received from the trusted server 116 at step S310 comprises the URL “http://www.exampleurl.com/bruno_noname/post”, a URL of a storage location in cache 118 of an image of a social media post, a URL of a storage location in cache 118 of a favicon, a creation time, a profile name, a username, and a URL of a storage location in cache 118 of a user picture. In accordance with embodiments described above, the communication client application 114 transmits a request for the image of the social media post to the cache 118 (the request comprising the URL of the image of the social media post identified in the received metadata), a request for the favicon to the cache 118 (the request comprising the URL of the favicon identified in the received metadata), a request for the user picture to the cache 118 (the request comprising the URL of the user picture identified in the received metadata), and a request for a thumbnail image of the social media post. In response to transmitting these requests the communication client application 114 receives the favicon, user picture and thumbnail image from the cache 118.

The communication client application 114 modifies the received instant message displayed in the client user interface in accordance with the received metadata and media content.

As shown in FIG. 5d, in an area 531 the received instant message is replaced with the received thumbnail image of the social media post 532, the URL 534, the favicon 535 associated with the URL, the creation time 536, the profile name 537, the username 538 and the received user picture 539.

FIG. 5e illustrates a client user interface that is presented by the communication client application 114 in response to detecting the URL of a webpage which displays a map image in a received IM message.

In the example of FIG. 5e, the metadata received from the trusted server 116 at step S310 comprises the URL of the webpage, a URL of a storage location in cache 118 of the map image, and the title of the map image displayed on the webpage at the URL (e.g. an address or location shown in the mapping image displayed on the webpage at the URL).

In accordance with embodiments described above, the communication client application 114 transmits a request for the map image to the cache 118. In response to transmitting this request the communication client application 114 receives the map image from the cache 118.

The communication client application 114 modifies the received instant message displayed in the client user interface in accordance with the received metadata and media content.

As shown in FIG. 5e, in an area 541 the received instant message is replaced with a thumbnail image 542 of the map image, and the title 543 of the map image.

The URL that is detected at step S306, may be displayed in the modified instant message in a number of ways. The full length URL that is detected at step S306 may be displayed in the modified instant message, as shown in FIGS. 5b and 5c. In other embodiments, the communication client application 114 is configured to only display the domain name (domain plus domain suffix) of the detected URL in the modified instant message as shown in FIG. 5a. In other embodiments, the communication client application 114 is configured to only display the domain of the detected URL in the modified instant message as shown in FIG. 5d. In other embodiments, the communication client application 114 is configured to not display the detected URL at all (i.e. is not displayed in its original or modified form) as shown in FIG. 5e. The manner in which the communication client application 114 displays the URL that is detected at step S306 in the modified image may be configured by the software provider of the communication client application 114.

Embodiments have been described above with reference to a two-stage approach whereby the communication client application 114 (i) transmits a request for metadata for the webpage pointed to by the URL in the received instant message; and (ii) transmits a request to the cache 118 in order to retrieve the media content identified in the metadata. This two-stage approach is advantageous in that it can be supported by any communication client application including any web-based communication client application. However, the latency of the two-stage approach may suffer due to the time taken for the trusted server 116 saving media content to the cache 118.

Embodiments of the present disclosure extend to a multi-part response approach whereby the communication client application 114 sends a single request to the trusted server 116, the request specifying the URL that was detected in the received instant message. In the multi-part response approach the URL preview module 117 sends a single response (comprising metadata and media content) to the communication client application 114 as soon as it all becomes available to the URL preview module 117.

That is, once the metadata data has been extracted following the HTML page parsing process being performed on the HTML page source code text, and all of the images identified in the extracted metadata have been downloaded from the third party server 120, a single response comprising the extracted metadata and the image(s) is transmitted from the URL preview module 117 to the communication client application 114.

The single response may be transmitted once the downloaded images have been optimised by the URL preview module 117.

In the multi-part response approach, the URL preview module 117 does not wait until the image(s) have been saved in the cache 118 before transmitting the response to the communication client application 114

It will be appreciated that in the multi-part response approach the URL preview module 117 transmits media content (in the single response) to the communication client application 114 rather than an indication of a storage location in the cache 118 where the media content can be accessed by the communication client application 114.

The multi-part response approach is advantageous in that it achieves a lower latency compared with the two-stage approach described above because the communication client application 114 does not have to wait for completion of the transfer of media content to the cache 118. It will be appreciated by persons skilled in the art that a web-based communication client application cannot handle a multi-part response, therefore web-based communication client applications should use the two-stage approach described above. Native communication client applications (e.g. for iOS, Windows Mobile, MacOS, Windows etc.) may add a special header field to the request transmitted to the trusted server 116 at step S308 to inform the URL preview module 117 about their capabilities i.e. their readiness to consume a multipart response. Web-based communication client applications will not add this header field into requests, thus the trusted server 116 is able to respond accordingly. As an alternative, native communication client applications may add “get parameters” to the request to inform the the URL preview module 117 about their capabilities.

In accordance with embodiments described above, the communication client application 114 provides a preview of the URL detected in the received instant message by enhancing the message with media content to make sharing of URL's more engaging during the instant messaging communication session.

In accordance with embodiments described above, the communication client application 114 does not communicate with the third party server 120. All communication with the third party server 120 is performed by the trusted server 116. Thus in order to modify received instant messages comprising URL's the communication client application 114 only has to communicate with the trusted server 116 and the cache 118 (in the two-stage approach). This advantageously ensures that the privacy of User B 110 is maintained in that his IP address and other private identity information is not shared with the third party server 120. Furthermore, the second user terminal 108 is not exposed to any illegal content, or any viruses, malware, spyware or any other malicious code in generating the modified instant message. In embodiments, if the trusted server 116 determines that the URL identified in the request received at step S322 points to harmful/illegal content, the trusted server 116 is configured to deliver this knowledge to the communication client application 114 by way of the category property (e.g. category: [harmful|illegal]) in the metadata transmitted to the communication client application 114 at step S336.

In a certain scenario, determined metadata of a URL may not comprise any reference to an image. For example URL may point to private storage space, thus content is not accessible to the URL preview module 117 because user's authorization is required to access this content. In this scenario, content is not fetched from the private storage space, however it is still possible to determine metadata associated with the URL (for example the file format, the type of content that the link directs to, and the hosting service that hosts the content) and return it to the communication client application 114. The communication client application 114, in response to receiving this metadata may modify a displayed instant message to provide a preview of the URL by displaying predetermined icons representing the file format, content type, and the hosting service.

In embodiments described above, the received message that comprises the URL 410 does not comprise any other text. It will be appreciated that a received message may be a composite message in that it comprises text and a URL 410, for example “check this out: http://www.exampleurl.com”. As described above at step S306, the communication client application 114 processes the received instant message to determine if the received instant message comprises a URL. Thus in the above described embodiments, the communication client application 114 is operable to modify a received instant message comprising a URL 410 regardless of whether the received instant message comprises other text or not. In alternative embodiments, the communication client application 114 is operable to modify a received instant message comprising a URL 410 only if the received message comprises no other text (i.e. is not a composite message).

Whilst embodiments have been described above with reference to the communication client application 114 modifying a received instant message comprising a URL 410. Embodiments of the present disclosure also extend to the modification of displayed transmitted instant messages that comprise a URL 410. That is, both terminals participating in an instant messaging communication session may make requests to the URL preview module 117 to obtain URL previews for URLs found in the body of incoming and outgoing messages.

Embodiments of the present disclosure are described above with reference to User A 104 and User B 110 engaging in an instant messaging conversation. The client user interface provided by the communication client application 114 displays content—including the transmitted and received messages—in an available area 400 of the display 204. As depicted in FIG. 4, the available area of the display is the whole of the display. However, it is envisaged that the available area of the display (that is the area available to the client 108) may constitute only a portion of the display e.g. with the remainder of the display being used by the operating system and/or other application(s) executed thereon to display other content.

Whilst embodiments have been described above with reference to an instant messaging communication session conducted between two users. It will be appreciated that embodiments extend to group instant messaging communication sessions whereby three or more users are participating.

Whilst embodiments have been described above with reference to a URL, persons skilled in the art will appreciate that a URL is an example of a URI, and embodiments described herein also extend to a URI exchanged during an instant messaging communication session.

A first aspect of the present disclosure has been described above.

The method may further comprise determining metadata associated with the uniform resource indicator to determine a storage location on the further network entity storing the media content.

The uniform resource indicator may refer to a Hypertext Markup Language (HTML) webpage, and determining metadata of the webpage may comprise: accessing the webpage associated with the uniform resource indicator to retrieve source code text of the webpage; and parsing the retrieved source code text of the webpage.

Retrieving media content associated with the uniform resource indicator may comprise retrieving the media content from the further network entity using at least one further uniform resource indicator identified from said parsing step.

The media content retrieved from the further network entity may comprise one or more of: a favicon associated with the webpage; an image of a user that is the owner of data on the webpage; and an image displayed on the webpage.

The uniform resource indicator may refer to the media content stored by the further network entity.

Retrieving media content associated with the uniform resource indicator may comprise retrieving the image from the further network entity.

Determining metadata associated with the uniform resource indicator may comprise determining metadata associated with the retrieved image.

The method may further comprise optimising the retrieved media content prior to storing the retrieved media content in the data store.

Optimising the retrieved media content may comprise rescaling the media content to reduce its data size.

The method may further comprise performing said optimisation based on detecting capabilities of said user terminal and/or detecting characteristics of a network connection over the communications network between the user terminal and the network entity.

The capabilities of said user terminal may comprise a resolution of a display on the user terminal.

The request may further comprise an indication of the capabilities of said user terminal, the method further comprising detecting capabilities of said user terminal based on the received request.

The characteristics of the network connection comprise a network connection type.

The request may further comprise an indication of the characteristics of the network connection, the method further comprising detecting characteristics of the network connection based on the received request.

In embodiments where the response comprises the determined metadata and the at least one identifier of a location in the data store where the retrieved media content was stored, the method may comprise delaying transmission of the response until the retrieved media content has been stored in the data store.

In embodiments where the response comprises the determined metadata and the retrieved media content, the method may comprise transmitting the response irrespective of whether the storing of the retrieved media content in the data store is complete.

The method may further comprise determining that the media content associated with the uniform resource indicator is stored at a private storage location on the further network entity; and in response to said determination, transmitting a response to said user terminal, comprises only the determined metadata.

The communications network may be a packet based network.

The steps shown separately in FIGS. 3a and 3b may or may not be implemented as separate steps.

Generally, any of the functions described herein can be implemented using software, firmware, hardware (e.g., fixed logic circuitry), or a combination of these implementations. The terms “controller”, “functionality”, “component”, “module” and “application” as used herein generally represent software, firmware, hardware, or a combination thereof. In the case of a software implementation, the controller, functionality, component, module or application represents program code that performs specified tasks when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors.

For example, the user terminals may also include an entity (e.g. software) that causes hardware of the user terminals to perform operations, e.g., processors functional blocks, and so on. For example, the user terminals may include a computer-readable medium that may be configured to maintain instructions that cause the user terminals, and more particularly the operating system and associated hardware of the user terminals to perform operations. Thus, the instructions function to configure the operating system and associated hardware to perform the operations and in this way result in transformation of the operating system and associated hardware to perform functions. The instructions may be provided by the computer-readable medium to the user terminals through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method implemented at a network entity during an instant messaging communication session conducted between a plurality of user terminals over a communications network, the method comprising:
receiving a request over the communications network from one of said user terminals, the request comprising a uniform resource indicator that has been exchanged in an instant message during the instant messaging communication session;
retrieving media content associated with the uniform resource indicator from a further network entity connected to said network;
storing the retrieved media content in a data store connected to said network; and
transmitting a response to said user terminal, the response comprising one of (i) at least one identifier of a location in the data store where the retrieved media content was stored; and (ii) the retrieved media content.

2. The method of claim 1, wherein the method further comprises determining metadata associated with the uniform resource indicator to determine a storage location on the further network entity storing the media content.

3. The method of claim 2, wherein the uniform resource indicator refers to a Hypertext Markup Language (HTML) webpage, and determining metadata of the webpage comprises:
accessing the webpage associated with the uniform resource indicator to retrieve source code text of the webpage; and
parsing the retrieved source code text of the webpage.

4. The method of claim 3, wherein retrieving media content associated with the uniform resource indicator comprises retrieving the media content from the further network entity using at least one further uniform resource indicator identified from said parsing step.

5. The method of claim 2, wherein the media content retrieved from the further network entity comprises one or more of: a favicon associated with the webpage; an image of a user that is the owner of data on the webpage; and an image displayed on the webpage.

6. The method of claim 1, wherein the uniform resource indicator refers to the media content stored by the further network entity.

7. The method of claim 1, further comprising optimising the retrieved media content prior to storing the retrieved media content in the data store.

8. The method of claim 7, wherein optimising the retrieved media content optionally comprises rescaling the media content to reduce its data size.

9. The method of claim 7, further comprising performing said optimisation based on detecting capabilities of said user terminal and/or detecting characteristics of a network connection over the communications network between the user terminal and the network entity.

10. The method of claim 9, wherein the capabilities of said user terminal comprise a resolution of a display on the user terminal.

11. The method of claim 9, wherein the request further comprises an indication of the capabilities of said user terminal, the method further comprising detecting capabilities of said user terminal based on the received request.

12. The method of claim 9, wherein the characteristics of the network connection comprise a network connection type.

13. The method of claim 9, wherein the request further comprises an indication of the characteristics of the network connection, the method further comprising detecting characteristics of the network connection based on the received request.

14. The method of claim 1, wherein the response comprises the determined metadata and the at least one identifier of a location in the data store where the retrieved media content was stored, the method comprising delaying transmission of the response until the retrieved media content has been stored in the data store.

15. The method of any of claim 1, wherein the response comprises the determined metadata and the retrieved media content, the method comprising transmitting the response irrespective of whether the storing of the retrieved media content in the data store is complete.

16. The method of claim 2, further comprising:
determining that the media content associated with the uniform resource indicator is stored at a private storage location on the further network entity; and
in response to said determination, transmitting a response to said user terminal, comprises only the determined metadata.

17. The method of claim 1, wherein the uniform resource indicator is a uniform resource locator.

18. A computer program product, the computer program product being embodied on a non-transient computer-readable medium and configured so as when executed on a processor of a network entity during an instant messaging communication session conducted between a plurality of user terminals over a communications network, to perform the method of any preceding claim.

19. A network entity comprising a network interface and a module, wherein the module is configured to:
receive, via the network interface, a request transmitted over a communications network from a user terminal during an instant messaging communication session conducted between the user terminal and at least one further user terminal over the communications network, the request comprising a uniform resource indicator that has been exchanged in an instant message during the instant messaging communication session;
retrieve media content associated with the uniform resource indicator from a further network entity connected to said network;
store the retrieved media content in a data store connected to said network; and
transmit a response to said user terminal, the response comprising one of (i) at least one identifier of a location in the data store where the retrieved media content was stored; and (ii) the retrieved media content.

20. A method implemented at a user terminal during an instant messaging communication session conducted with at least one further user terminal over a communications network, the method comprising:
displaying a message exchanged during the instant messaging communication session on a display of the user terminal;
detecting that the message comprises a uniform resource indicator;
in response to said detection, automatically transmitting a request to a network entity over the communications network, the request comprising said uniform resource indicator;
receiving a response from said network entity, the response comprising at least one of (i) at least one identifier of a location in a data store connected to the network where media content associated with the uniform resource indicator is stored; and (ii) media content associated with the uniform resource indicator; and
modifying the displayed message in accordance with at least the media content associated with the uniform resource locator.
